(19) United States
(12) Patent Application Publication
(10) Pub. No.: US 2005/0069674 A1
(43) Pub. Date: Mar. 31, 2005

(54) Deform-proof composite board

(76) Inventor: Chia-Ming Chang, Lungtan Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/670,303

(22) Filed: Sep. 26, 2003

(51) Int. Cl. B32B 5/12

(52) U.S. Cl. 428/106; 428/172

(57) ABSTRACT

A composite board includes a first board having a first grain, a second board having a second grain, and a mediate board securely sandwiched between the first board and the second board. The mediate board has a grain perpendicular to the first grain and the second grain such that deformation of the composite board is avoided as interaction among the first grain, the second grain and the grain harmonizes expansion or contraction of the first board and the second board.

### BACKGROUND OF THE INVENTION

1. Field of the Invention

The present invention relates to a board, and more particularly to a composite board composed of a mediate board sandwiched between at least a first board and at least a second board. The mediate board has a grain perpendicular to a first grain of the first board and a second grain of the second board such that when the first board and the second board are securely attached to opposite sides of the mediate board, expansion and contraction of the mediate board due to drastic temperature change is harmonized and therefore deformation of the combination of the first board, second board and the mediate board is avoided.

2. Description of Related Art

A conventional board comprises a solid board containing a plurality of recesses defined in a bottom thereof and including a first side formed with a tongue and a second side containing a groove therein.

Conventional boards are assembled into a wood covering such as a floor or a wall by inserting the tongue of each of the boards into the groove of the adjacent board. In such a manner, the configuration of the solid boards will be distorted or deformed by stresses due to change of temperature or humidity of the environment.

When the board is employed on the floor especially, because the floor is a very good heat conductor and easily absorbs moisture from the environment, cracks and deformation of the floor boards are common all over the world, unless a fine wood is chosen to be the base of the combination of the conventional composite board. However, using the fine board as the base of the conventional composite board usually is not affordable for anyone who is planning to change the floor.

To overcome the shortcomings, the present invention tends to provide an improved composite board to mitigate and obviate the aforementioned problems.

### SUMMARY OF THE INVENTION

The primary objective of the present invention is to provide an improved composite board, a mediate board, at least a first board and at least a second board together with the first board to sandwich the mediate board therebetween. The mediate board has a grain and the first board has a first grain and the second board has a second grain. Both the first and second grains are perpendicular to the grain of the mediate board so that stress among the mediate board, the first and the second board is harmonized and thus deformation of the composite board is avoided.

Another objective of the present invention is that the mediate board has a grain, the first board has a first grain and the second has a second grain. The grain of the mediate board is perpendicular to both the first and the second grains so that stress among the first board, the mediate board and the second board is harmonized and deformation of the composite board of the present invention is avoided.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the composite board of the present invention;

FIG. 2 is an exploded perspective view of the second embodiment of the composite board of the present invention;

FIG. 3 is an exploded perspective view of the third embodiment of the composite board of the present invention;

FIG. 4 is an exploded perspective view of the fourth embodiment of the composite board of the present invention;

FIG. 5 is an exploded perspective view of the fifth embodiment of the composite board of the present invention;

FIG. 6 is an exploded perspective view of the sixth embodiment of the composite board of the present invention; and

FIG. 7 is an exploded perspective view of the seventh embodiment of the composite board of the present invention.

### DETAILED DESCRIPTION OF THE PREFERRED EMBODIMENT

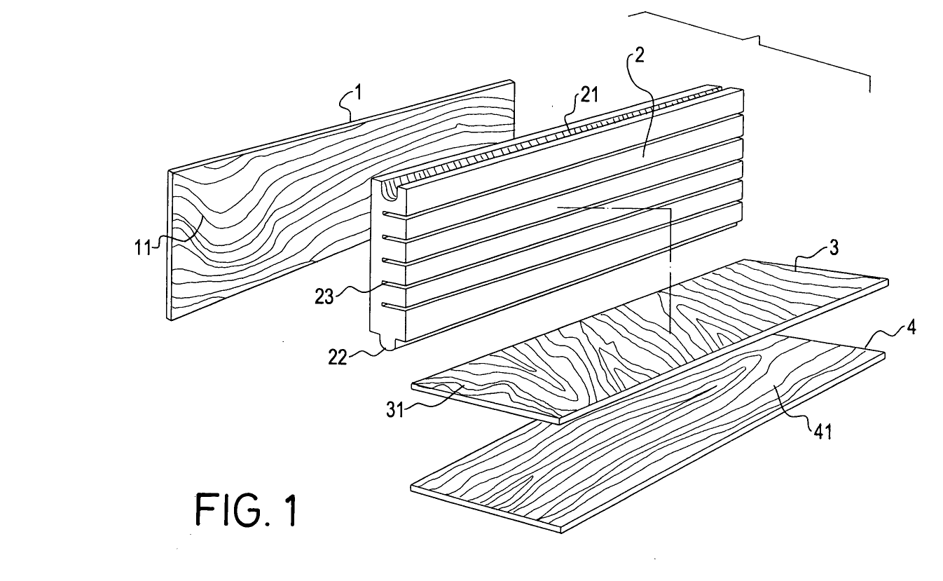

With reference to FIG. 1, the composite board in accordance with the present invention includes a first board (1), a mediate board (2), a second board (3) and a third board (4).

The first board (1) has a first grain (11). The second board (3) has a second grain (31) and the third board (4) has a third grain (41). It is to be noted that the first grain (11) is perpendicular to the second grain (31) which is perpendicular to the third grain (41). From the accompanying drawings, the first grain (11) is latitudinal, which is the same as that of the third grain (41). The second grain (31) is longitudinal and is thus perpendicular to both the first and third grains (11,41). The mediate board (2) is provided with a notch (21) defined in a side face of the mediate board (2), a tongue (22) oppositely formed relative to the notch (21) and multiple latitudinal slits (23) latitudinally defined across the mediate board (2). When the composite board is assembled to securely engage the first board (1), the mediate board (2), the second board (3) and the third board (4) together, due to the orientation differences among the first grain (11), the second grain (31) and the third grain (41), deformation of the composite board resulting from the temperature and/or humidity change in the composite board of the present invention is harmonized. That is, for example, when the second board (3) has expanded and the third board (4) has expanded as a consequence of additional moisture in the environment, differences between the expansion coefficients of the second board (3) and the third board (4) respectively cause different expansion in the second board (3) and the third board (4). However, due to the differences between the second grain (31) and the third grain (41), the expansion differences are counteracted by each other so that over expansions of the second and the third boards (3,4) are avoided. The same principle applies to the first board (1).

The provision of the latitudinal slits (23) in the mediate board (2) is able to provide space to accommodate excessive volume of the mediate board (2) when expanded so that stress in the composite board is obviated and thus cracks in the composite board are avoided.

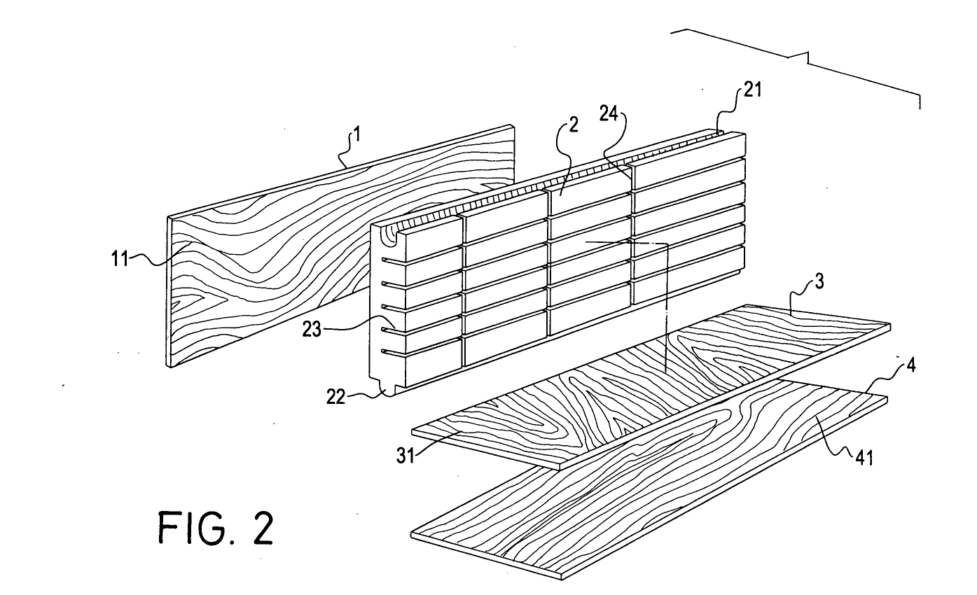

With reference to FIG. 2, it is noted that the second embodiment of the composite board has a structure almost the same as that of the first embodiment shown in FIG. 1. The only difference therebetween is that the mediate board (2) further has multiple longitudinal slits (24) each intersecting with the latitudinal slits (23) to reinforce the structural integrity.

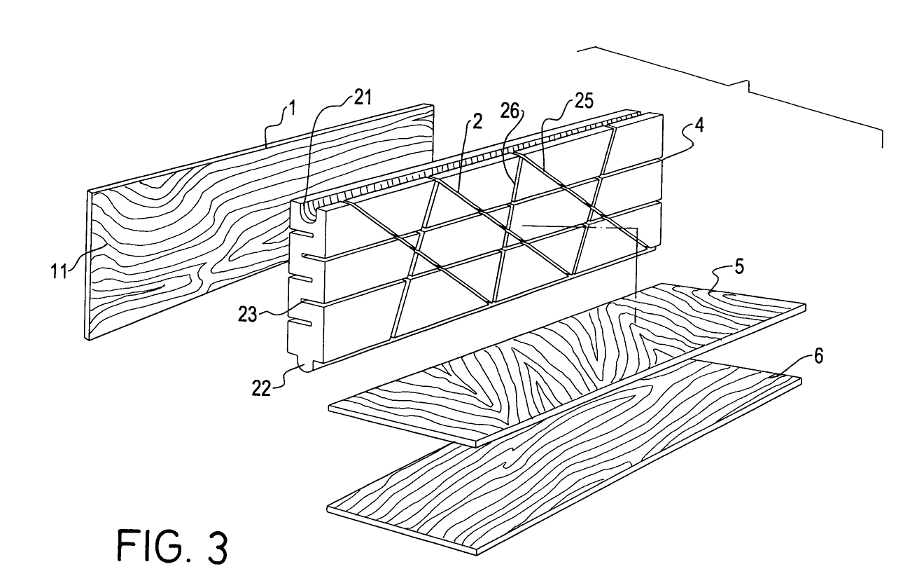

With reference to FIG. 3, it is noted that the third embodiment of the composite board has a structure almost the same as that of the first embodiment shown in FIG. 1. The only difference therebetween is that the mediate board (2) has multiple right slanted slits (25) intersecting with each one of the latitudinal slits (23), and multiple left slanted slits (26) each intersecting with each one of the latitudinal slits (23) and intersecting with a corresponding one of the right slanted slits (25). The provision of the right and left slanted slits (25,26) is to increase structural integrity of the composite board of the present invention.

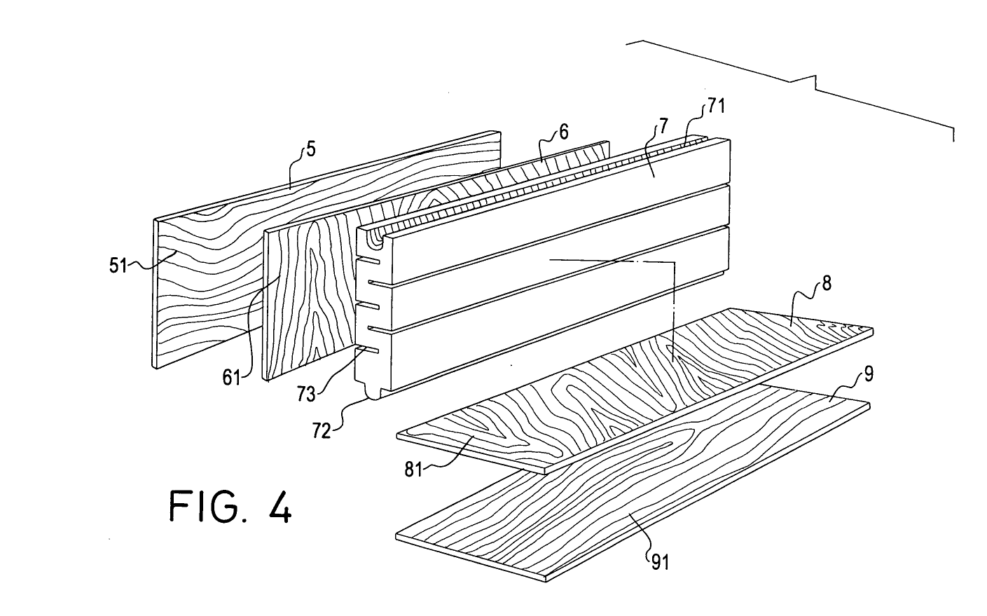

With reference to FIG. 4, the composite board in accordance with the present invention includes a first board (5), a second board (6), a mediate board (7), a third board (8) and a fourth board (9).

The first board (5) has a first grain (51), the second board (6) has a second grain (61), the third board (8) has a third grain (81) and the fourth board (9) has a fourth grain (91). The first and second boards (5,6) are provided on one side of the mediate board (7) and the third and the fourth boards (8,9) are provided to engage with the mediate board (7) and opposite to the combination of the first and second boards (5,6). The first board (S) has a first grain (51) and the second board (6) has a second grain (61) perpendicular to the first grain (51). The third board (8) has a third grain (81) and the fourth board (9) has a fourth grain (91) perpendicular to the third grain (81). The mediate board (7) has a notch (71) defined in a side face of the mediate board (7), a tongue (72) oppositely formed with respect to the notch (71), multiple top slits (73) defined in a top face of the mediate board (7) and multiple bottom slits (74) defined in a bottom face of the mediate board (7).

When the composite board of this preferred embodiment of the present invention is assembled to securely engage the first board (5), the second board (6), the mediate board (7), the third board (8) and the fourth board (9) together, because the first grain (51) is perpendicular to the second grain (61) and the third grain (81) is perpendicular to the fourth grain (91), deformation of the composite board from the change in humidity and temperature in the environment is avoided.

The provision of the top and bottom slits (73,74) is to increase the structural integrity of the composite board so that when the composite board has expanded due to a rise in temperature, as a result of different expansion coefficients in the first, second, third and fourth boards (5,6,8,9) the expansion is accommodated by the slits (73,74).

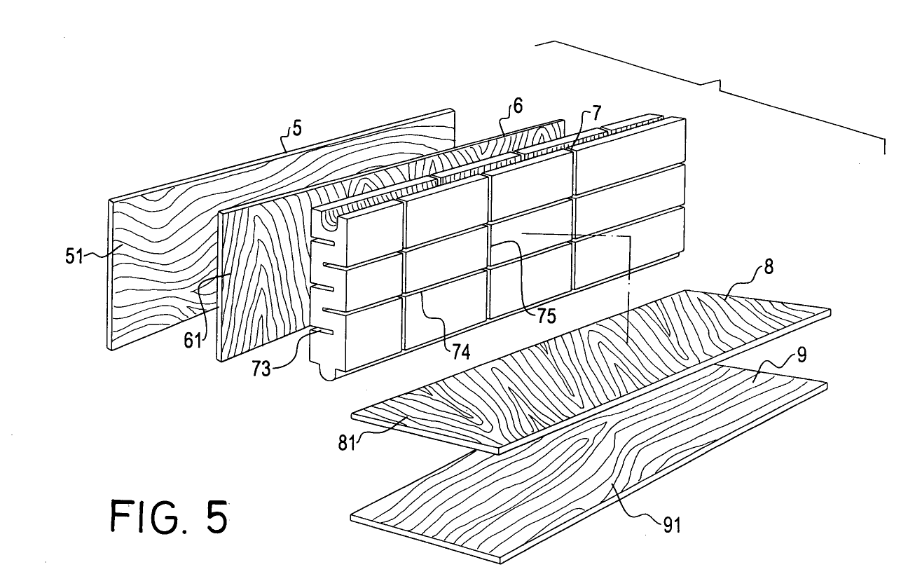

With reference to the embodiment in FIG. 5, the structure in this embodiment is almost the same as that disclosed in FIG. 4. The only difference is that the mediate board (7), except for the top and bottom slits (73,74), further has multiple longitudinal slits (75) defined in opposite side faces of the mediate board (7) to respectively intersect with the top slits (73) and the bottom slits (74).

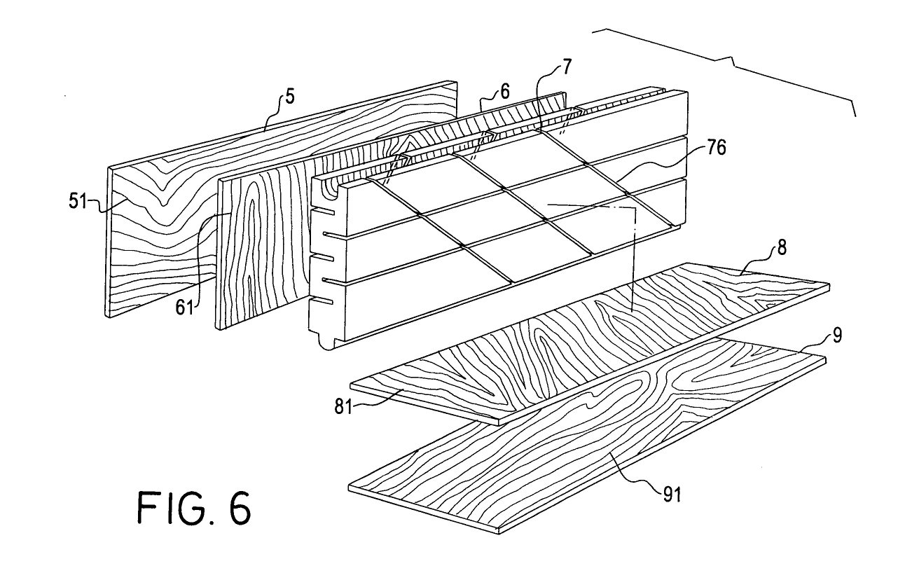

With reference to FIG. 6, the structure in this embodiment is almost the same as that disclosed in FIG. 4. The only difference is that the mediate board (7), except for the top and bottom slits (73,74), further has multiple left slanted slits (76) defined in the top face of the mediate board (7) to intersect with the top slits (73) and multiple right slanted slits (77) defined in the bottom face of the mediate board (7) to intersect with the bottom slits (74). The provision of the top and bottom slits (73,74) and the right and left slanted slits (76,77) is to increase the structural integrity of the composite board of the present invention so that when stress occurs in the composite board due to the different expansion coefficients of each of the boards, additional space is provided for the excessive volume of the expanded composite board from change of temperature and/or humidity.

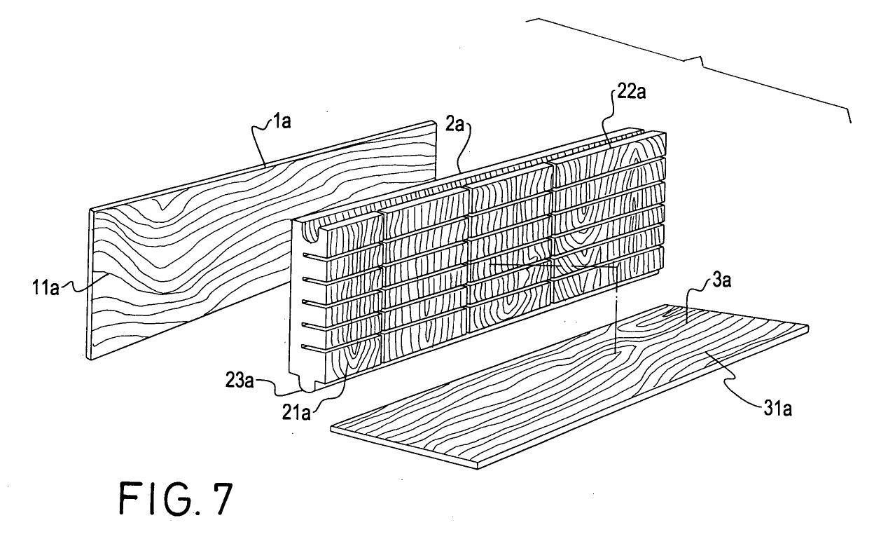

Different from what is disclosed in the foregoing embodiments, this embodiment shown in FIG. 7 has a first board (1a), a mediate board (2a) and a second board (3a). The first board (1a) has a grain (11a), the mediate board (2a) has a grain (21a) and the second board (3a) has a second grain (31a). The first grain (l a) is perpendicular to the grain (21a) which is perpendicular to the second grain (31a). The mediate board (2a) further has a notch (22a) defined in a side face of the mediate board (2a), a tongue (23a) oppositely formed relative to the notch (22a), multiple latitudinal slits (24a) defined in a side face of the mediate board (2a) and multiple longitudinal slits (25a) defined in the side face to intersect with the latitudinal slits (24a).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A composite board comprising:
a first board having a first grain;
a second board having a second grain; and
a mediate board securely sandwiched between the first board and the second board, the mediate board having a grain perpendicular to the first grain and the second grain such that deformation of the composite board is avoided as interaction among the first grain, the second grain and the grain harmonizes expansion or contraction of the first board and the second board.

2. The composite board as claimed in claim 1, wherein the mediate board further has a notch defined in a side face of the mediate board and a tongue oppositely formed relative to the notch to enable the composite board to connect to an adjacent composite board.

3. The composite board as claimed in claim 1, wherein the mediate board has multiple slits latitudinally defined across the mediate board to overcome stress resulting from temperature and humidity change inside the composite board.

4. The composite board as claimed in claim 2, wherein the mediate board has multiple latitudinal slits latitudinally defined across the mediate board to overcome stress resulting from temperature and humidity change inside the composite board.

5. The composite board as claimed in claim 4 further comprising a third board securely attached to a free side of the second board and having a third grain perpendicular to the second grain.

6. The composite board as claimed in claim 5, wherein multiple longitudinal slits are longitudinally defined in the mediate board to intersect with the latitudinal slits to reinforce structural integrity of the composite board.

7. The composite board as claimed in claim 4, wherein the mediate board further has multiple right slanted slits intersecting with each one of the latitudinal slits and multiple left slanted slits each intersecting with each one of the latitudinal slits and intersecting with a corresponding one of the right slanted slits to increase structural integrity of the composite board.

8. The composite board as claimed in claim 5, wherein the mediate board further has multiple right slanted slits intersecting with each one of the latitudinal slits and multiple left slanted slits each intersecting with each one of the latitudinal slits and intersecting with a corresponding one of the right slanted slits to increase structural integrity of the composite board.

9. A composite board comprising:
a first board having a first grain;
a second board securely attached to a side of the first board and having a second grain perpendicular to the first grain;
a mediate board securely attached to a free side of the second board and having a notch defined in a side face of the mediate board, a tongue oppositely formed with respect to the notch, multiple top slits defined in a top face of the mediate board and multiple bottom slits defined in a bottom face of the mediate board;
a third board securely attached to a free side of the mediate board and having a third grain; and
a fourth board securely attached to a free side of the third board and having a fourth grain perpendicular to the third grain,
whereby the tongue and the notch of the mediate board allows the composite board to connect to an adjacent composite board and the mutual perpendicular relationship between the first grain and the second grain and between the third grain and the fourth grain harmonize expansion or contraction of the composite board due to change of temperature and humidity in the composite board.

10. The composite board as claimed in claim 9, wherein the mediate board further has multiple longitudinal slits defined in opposite side faces of the mediate board to respectively intersect with the top slits and the bottom slits.

11. The composite board as claimed in claim 9, wherein the mediate board further has multiple left slanted slits defined in the top face of the mediate board to intersect with the top slits.

12. The composite board as claimed in claim 11, wherein the mediate board further has multiple right slanted slits defined in the top face of the mediate board to intersect with the bottom slits.
